(19) United States
(12) Patent Application Publication
(10) Pub. No.: US 2003/0118797 A1
(43) Pub. Date: Jun. 26, 2003

(54) Structure for multi-layer conductive via and circuit and method for making same

(76) Inventors: Robin Fluman, Glendale, AZ (US); Ken Gann, Glendale, AZ (US)

Correspondence Address: Jeff Whitley, Greenberg Traurig LLP, 2375 East Camelback Rd., Suite 700, Phoenix, AZ, 85016, US

(21) Appl. No.: 10/033,405

(22) Filed: Dec. 26, 2001

(51) Int. Cl. B32B 3/00

(52) U.S. Cl. 428/209; 428/458; 428/901

(57) ABSTRACT

A multi-layer conductive via structure and multi-layer circuit structure containing such multi-layer via structure are described along with the methods for making the structures. The structures include conductive material filled opening(s) located within flexible substrate layers that are supported by an adhesive layer.

### FIELD OF INVENTION

The present invention generally relates to a structure for a multi-layer conductive via and multi-layer circuit having a multi-layer conductive via and methods for making the same. More particularly, the present invention is directed to a multi-layer conductive via which includes a conductive material filled opening located within flexible substrate layers that are supported by an adhesive layer. Patterned conductive ink may overlie the flexible substrate layers to connect circuits via the multi-layer conductive via.

### BACKGROUND OF THE INVENTION

In an effort to increase the speed and decrease the size of electronic systems, multi-layer electronic circuits are being used to increase circuit densities while still maintaining circuit efficiency and reliability. Typically, three different methods are currently being used for interconnecting two or more separate polyester circuit layers. In one method, a tail on each circuit layer is used and are terminated together after building the multi-layer circuit. However, alignment of the tails is difficult using this method if the circuit trace spacing goes below 0.100 inch centers. Also, this method allows for only a limited number of interconnections between layers.

Another method utilizes fold over circuits where upper and lower circuits are composed of a single printed circuit and that single printed circuit is then folded over to create an upper circuit and a lower circuit. A third method utilizes a conductive Z-axis adhesive which allows electrical signals to travel between layers. This method requires mechanical clamping to ensure a good electrical connection. However, Z-axis adhesives that are currently on the market are not very reliable.

Other methods for creating multi-layer circuits are also known in the art. For example, U.S. Pat. No. 5,733,427 issued to Kawakita et al. discloses a multi-layer printed circuit board which includes inner-via hole connections that utilize a conductive paste. More specifically, a laminated porous base material disposed with through-holes is filled with conductive paste and positioned between two sheets of double-sided printed circuit board. The structure is then heated and pressurized to form a multi-layer printed circuit board having multi-layer conductive vias.

Another example of multi-layer electronic circuits is described in U.S. Pat. No. 5,364,750 issued to Hatakeyama et al. which discloses a porous substrate and conductive ink-filled vias for printed circuits. More specifically, this patent reference discloses a method of manufacturing an organic substrate used for printed circuit boards which includes the steps of (1) forming through-holes in a porous raw material having polyester cover films, (2) filling electro-conductive paste into the through-holes, (3) separating the polyester cover films from the porous raw material filled with the electro-conductive paste in its through-holes, (4) applying metal foils onto the surfaces of the porous raw material from which the polyester cover films have been separated, and (5) compressing the porous raw material applied with the metal foils through feeding and pressurization.

Still other examples of multi-layer printed circuit boards are described in U.S. Pat. Nos. 5,688,584 and 5,727,310, both issued to Casson et al. The multi-layer circuit boards have three or more conductive layers with at least two of those layers electrically and mechanically connected by an interconnecting adhesive layer. The interconnecting adhesive layer includes a conductive adhesive material having a plurality of deformable, heat fusible metallic particles dispersed substantially throughout a non-conductive adhesive. This layer is similar to the Z-axis adhesive layer described above.

Although several methods exist for creating multi-layer printed circuits, there is a need for a simple, reliable and cost effective method for producing multi-layer printed circuit boards which allow for high interconnect density and which are not limited by number of layers which may be used to form such a multi-layer printed circuit.

### SUMMARY OF THE INVENTION

The present invention provides a multi-layer circuit having a multi-layer conductive via structure which includes a first layer of flexible substrate, a conductive ink overlying the first flexible substrate layer, an adhesive layer having an opening which overlies the conductive ink, a second flexible substrate layer having an opening which overlies the adhesive layer so that the openings in the adhesive and flexible substrate layers are aligned with one another, and a conductive material which fills the aligned openings. The multi-layer conductive via may also include a conductive trace overlying the second flexible substrate layer which lies adjacent to, and is in contact with, the conductive material that fills the via.

The multi-layer circuit structure, which includes the multi-layer via structure, generally includes a first substrate layer, a conductive circuit formed on the substrate layer using conductive ink, an adhesive layer having at least one opening which overlies the conductive circuit formed on the substrate, a flexible layer having at least one opening which overlies the adhesive layer so that at least one opening in both the adhesive and flexible layers are aligned with one another, a second conductive circuit formed on the flexible layer so that the circuit lies adjacent to at least one set of aligned openings in the adhesive and flexible layers, and a conductive material layer that fills the aligned openings. The multi-layer circuit structure may further include a plurality of adhesive and flexible layers having openings where one or more of the openings in the respective layers are aligned with one another, a plurality of conductive circuits formed on the flexible layers so that the circuits lie adjacent to at least one set of aligned openings, and a plurality of conductive material layers which fill the aligned openings. The multi-layer conductive via structures contained in the multi-layer circuit structures may span an unlimited number of adhesive and flexible layers.

In one aspect of the present invention, the conductive ink in the multi-layer conductive via and the conductive circuit in the multi-layer circuit comprise a silver based ink, a carbon ink, or a two-part cure conductive epoxy.

In another aspect of the present invention, the adhesive layer in the multi-layer conductive via structure and multi-layer circuit structure preferably comprises an acrylic adhesive and the flexible and substrate layers preferably comprise a polymer.

In still another aspect of the present invention, the conductive material used to fill aligned openings in the multi-layer conductive via structure and multi-layer circuit structure preferably comprise a conductive ink having a conductive ink base that may be a vinyl, polyester or epoxy material.

The present invention also provides a method for making a multi-layer conductive via which includes the steps of forming a first flexible layer, applying a conductive ink to that first layer, applying an adhesive layer having at least one opening over the first layer so that the opening overlies the conductive ink, applying a second flexible layer having at least one opening over the adhesive layer so that at least one opening in the adhesive layer and second flexible layer are each aligned with one another, and filling the aligned openings with a conductive material.

A method for making a multi-layer circuit is also provided by the present invention. The method includes the steps of forming a first substrate layer, forming a conductive circuit on the substrate layer using a conductive ink, applying an adhesive layer having at least one opening over the substrate layer and circuit so that the opening in the adhesive layer overlies the circuit, applying a flexible layer having at least one opening over the adhesive layer so that at least one opening in the adhesive and flexible layers are each aligned with one another, forming a second conductive circuit on the flexible layer so that the second conductive circuit lies adjacent to at least one set of aligned openings in the adhesive and flexible layers, and filling the aligned openings with a conductive material. In order to provide an unlimited number of layers in the multi-layer circuit, the method may further include the step of alternately applying adhesive layers having at least one opening and flexible layers having at least one opening and at least one conductive circuit formed thereon so that at least one set of openings in the adhesive and flexible layers are aligned with one another and at least one set of aligned openings lie adjacent to at least one conductive circuit.

In one aspect of the above described methods, the steps of applying a conductive ink and forming a conductive circuit comprise at least one of screen printing the ink, stencil printing the ink, or directly applying the ink using a syringe dispenser.

In another aspect of the above described methods, the steps of applying adhesive and flexible layers preferably comprise the step of applying pressure to those respective layers and, the step of applying pressure preferably comprises applying pressure with a hand roller or opposing machine rollers.

In still another aspect of the above described methods, the step of filling the aligned openings with a conductive material may comprise the step of filling the openings with a two part cure conductive which cures at room temperature or, alternatively, the above described methods may further comprise the step of curing the conductive material at an elevated temperature.

### BRIEF DESCRIPTION OF THE DRAWINGS

The present invention is illustrated by way of example, and not by way of limitation, in the figures of the accompanying drawings. Corresponding numerals and symbols in the different figures refer to corresponding parts unless otherwise indicated.

FIG. 1 is a cross sectional view of one embodiment of a multi-layer conductive via structure of the present invention.

FIG. 2 is a top plan view of the multi-layer conductive via structure shown in FIG. 1.

FIG. 3 is a cross sectional view of a multi-layer circuit structure containing the multi-layer conductive via structure shown in FIG. 1 along with other embodiments of multi-layer conductive via structures in accordance with the present invention.

FIG. 4 is a top plan view of the multi-layer circuit structure shown in FIG. 3.

FIG. 5 is a flowchart showing the method of the present invention for making a multi-layer conductive via.

### DETAILED DESCRIPTION

Improved multi-layer conductive via structures and multi-layer circuits containing those structures and methods of fabrication are described. In the following detailed specification, numerous specific details are set forth, such as materials, thicknesses, processing sequences, etc., in order to provide a thorough understanding of the present invention. However, it will be apparent to one skilled in the art that the present invention may be practiced without these specific details. In certain instances, manufacturing processes, materials and equipment, well known in the art, have not been described in detail in order to avoid unnecessarily obscuring the present invention.

The present invention is described in connection with multi-layer conductive via structures, multi-layer circuits containing such multi-layer conductive via structures, and the methods to manufacture them. The first embodiment illustrates a multi-layer conductive via structure which includes an adhesive layer contained between two flexible substrate layers having conductive material formed thereon to provide a circuit. The second embodiment illustrates a multi-layer circuit structure containing the previously described multi-layer conductive via structure embodiment along with other embodiments of multi-layer conductive via structures. The second embodiment includes multiple multi-layer conductive via structures that are formed by alternating adhesive layers and flexible layers having conductive circuits formed thereon. However, it will be understood by those of ordinary skill in the art that the present invention can also be readily implemented into other processes and multi-layer via structures and multi-layer circuits containing such structures.

FIG. 1 is a vertical cross-sectional view of a multi-layer conductive via structure 10 according to a first embodiment of the present invention. Multi-layer conductive via structure 10 includes a first layer flexible substrate 12, a conductive ink 14 overlying first flexible substrate layer 12, an adhesive layer 16 having at least one opening overlying conductive ink 14, a second layer of flexible substrate 22 having at least one opening overlying adhesive layer 16 such that the openings in adhesive layer 16 and second flexible substrate layer 22 are aligned with one another, and a conductive material 20 filling the aligned openings. Multi-layer conductive via structure 10 may also include a conductive trace 24 overlying second flexible substrate layer 22 which lies in contact with conductive material 20 that fills the via.

Conductive ink 14 can be applied to first flexible substrate layer 12 by screen printing, by stencil printing, or by directly applying conductive ink 14 with a syringe dispenser. First flexible substrate layer 12 preferably comprises a thickness of about 0.003 inch to 0.007 inch. Examples of conductive ink 14 which may be used in the present invention include, but are not limited to, silver-based inks such as 28RF100C COND SILVER INK manufactured by Acheson, Inc. and 3082 LO CURE SILVER INK manufactured by Acme, Inc. Alternatively, conductive ink 14 may comprise a carbon ink or a two-part cure conductive epoxy. Further, conductive ink 14 has a conductive ink base that may comprise a vinyl, polyester, or epoxy material.

Adhesive layer 16 preferably comprises an acrylic adhesive and is applied by hand to first flexible substrate layer 12 having conductive ink 14 thereon with the use of a hand roller or laminating machine. Application of adhesive layer 16 occurs at room temperature. Adhesive layer 16 preferably comprises a thickness of about 0.002 inch to 0.009 inch and may be comprised of an adhesive such as 7955 MP 0.005 manufactured by 3M, Inc. Second flexible substrate layer 22 is applied by hand to adhesive layer 16 and pressed down in much the same way as adhesive layer 16 is pressed down on first flexible substrate layer 12 having conductive ink 14 thereon. Specifically, a hand roller or laminating machine may be used to press second flexible substrate layer 22 onto adhesive layer 16. Second flexible substrate layer 22 preferably comprises a thickness of about 0.005 inch and preferably comprises a polyester or polycarbonate. An example of a polyester that may be used for second flexible substrate layer 22 includes, but is not limited to, 0.005 MELINEX 561 manufactured by DuPont, Inc. Conductive trace 24 preferably comprises the same materials as conductive ink 14. Although specific examples of materials have been included with this description, those skilled in the art will recognize that any materials standard to the membrane switch and flex print industries may be used in the present invention.

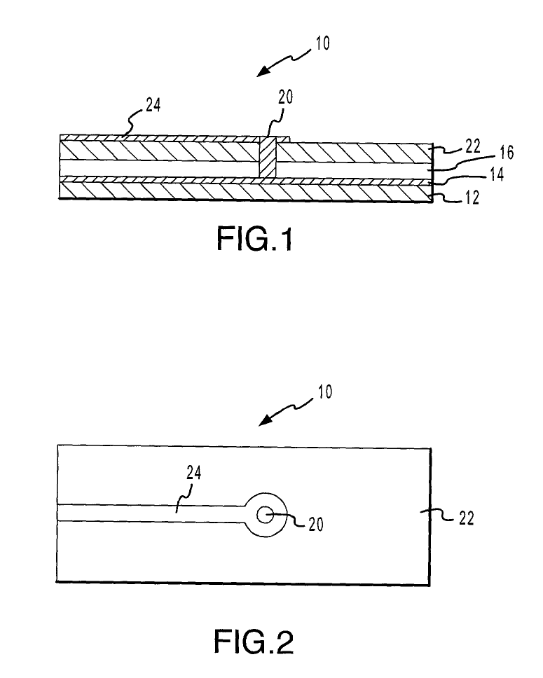

A top plan view of multi-layer conductive via structure 10 is shown in FIG. 2. Conductive trace 24 is contained on second flexible substrate layer 22 and lies adjacent to conductive material 20 which fills openings contained in adhesive layer 16 and second flexible substrate layer 22 to create an electrical connection.

All of the assembly processes for the present invention occur at room temperature. However, conductive inks used in the present invention may be cured at an elevated temperature. Alternatively, conductive inks used in forming the present invention may consist of a two-part epoxy that cures at room temperature.

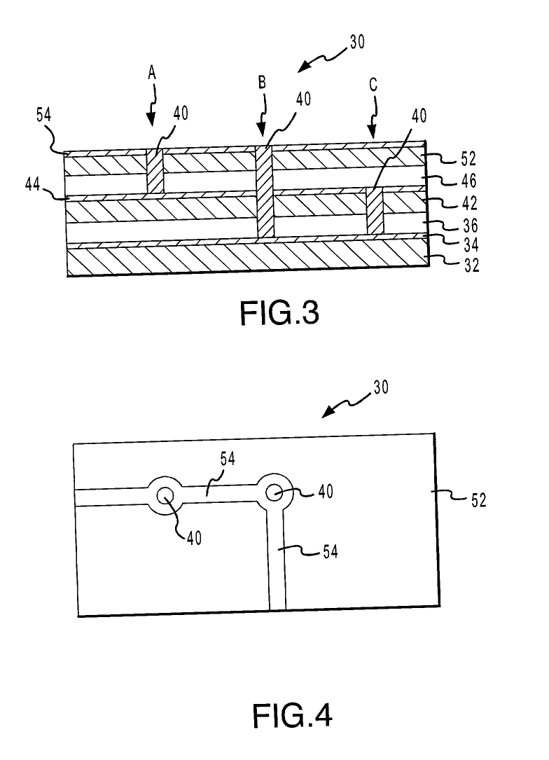

Turning now to FIG. 3, there is shown a cross-sectional view of a multi-layer circuit structure 30 containing multi-layer conductive via structure 10 shown in FIG. 1 along with other embodiments of multi-layer conductive via structures in accordance with the present invention. Multi-layer circuit structure 30 includes a first substrate layer 32, a conductive circuit 34 formed on substrate layer 32 using conductive ink, a first adhesive layer 36 having at least one opening overlying conductive circuit 34 formed on substrate 32, a first flexible layer 42 having at least one opening overlying first adhesive layer 36 so that at least one opening in first adhesive layer 36 and first flexible layer 42 are aligned with one another, a second conductive circuit 44 formed on first flexible layer 42 such that it lies adjacent to at least one set of aligned openings contained in first adhesive layer 36 and first flexible layer 42, a second adhesive layer 46 having at least one opening contained therein overlying second conductive circuit 44, a second flexible layer 52 having at least one opening overlying an opening contained in second adhesive layer 46, and a third conductive circuit 54 formed on second flexible layer 52 such that third conductive circuit 54 comes into contact with one of more aligned openings contained in second adhesive 46 and second flexible layer 52, as well as openings in first adhesive layer 36 and first flexible layer 42, which are all filled with conductive material 40.

As shown in FIG. 3, multi-layer via structure A spans second adhesive layer 46 and second flexible layer 52. Multi-layer via structure B spans first adhesive layer 36, first flexible layer 42, second conductive circuit 44, second adhesive layer 46, and second flexible layer 52. In contrast, multi-layer conductive via structure C is a buried via and spans only first adhesive layer 36, first flexible layer 42, and second conductive circuit 44.

A top plan view of multi-layer circuit structure 30 is shown in FIG. 4. In FIG. 4, third conductive circuit 54 lies adjacent to, and is in contact with, conductive material 40 which fills multi-layer vias A, B and C. Therefore, in accordance with the embodiment shown in FIGS. 3 and 4, electrical connections are made between third conductive circuit 54 and second conductive circuit 44 as well as between third conductive circuit 54 and conductive circuit 34.

The multi-layer circuit structure of the present invention may further include additional adhesive and flexible layers having openings where one or more of the openings in the respective layers are aligned with one another, a plurality of conductive circuits formed on the flexible layers so that the circuits lie adjacent to at least one set of aligned openings, and a plurality of conductive materials which fill the aligned openings. The multi-layer conductive via structures of the present invention contained in the multi-layer circuit structures of the present invention may span an unlimited number of adhesive and flexible layers.

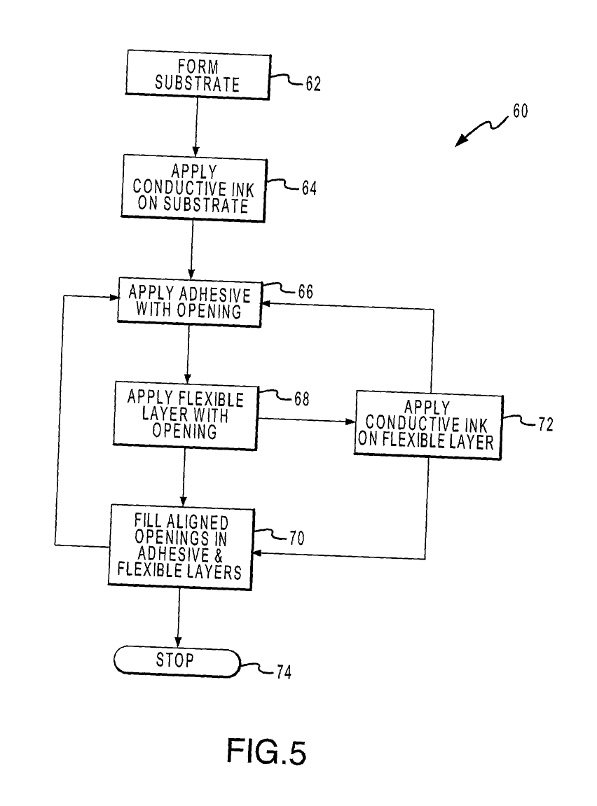

A flow chart showing an exemplary method 60 for making a multi-layer conductive via in accordance with the present invention is shown in FIG. 5. Method 60 includes forming a first substrate layer in step 62, forming a conductive circuit on the substrate layer using a conductive ink in step 64, applying an adhesive layer having at least one opening in step 66 over the substrate layer and circuit so that the opening in the adhesive layer overlies the circuit, applying a flexible layer having at least one opening in step 68 over the adhesive layer so that at least one opening in the adhesive and flexible layers are each aligned with one another, forming another conductive circuit on the flexible layer in step 72 so that the second conductive circuit lies adjacent to at least one set of aligned openings in the adhesive and flexible layers, and filling the aligned openings with a conductive material in step 70.

The method of the present invention may be used to form a multi-layer circuit having an unlimited number of layers by further including the step of alternately applying adhesive layers having at least one opening and flexible layers having at least one opening and at least one conductive circuit formed thereon so that at least one set of openings in the adhesive and flexible layers are aligned with one another and at least one set of aligned openings lie adjacent to at least one conductive circuit. The formation of alternating flexible and adhesive layers continues to form a multi-layer circuit until the process is stopped in step 74.

The method of the present invention is much more reliable than previous methods and does not require mechanical clamping. The method of the present invention for forming multi-layer conductive vias and multi-layer circuits containing multi-layer conductive vias allows for i) the creation of buried vias and ii) the practical construction of three or more polyester circuit layers.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. The multi-layer conductive via and multi-layer circuit structures of the present invention can be used to replace the multi-layer printed circuit board that is currently used throughout the electronics industry. Specific applications for the multi-layer conductive via and multi-layer circuit structures of the present invention include, but are not limited to, remote controls, control panels, keyboards, cell phones, and other electronic products.

We claim:

1. A multi-layer conductive via comprising:
a) a first layer of flexible substrate;
b) a conductive ink overlying said first layer;
c) an adhesive layer having an opening therein overlying said conductive ink;
d) a second layer of flexible substrate having an opening therein overlying said adhesive layer such that said openings are aligned with one another; and
e) a conductive material layer filling said aligned openings.

2. The multi-layer conductive via of claim 1 further comprising a conductive trace overlying said second layer such that said conductive trace lies in contact with said material layer.

3. The multi-layer conductive via of claim 1 wherein said conductive ink preferably comprises at least one of a silver based ink, a carbon ink, and two part cure conductive epoxy.

4. The multi-layer conductive via of claim 1 wherein said adhesive layer preferably comprises an acrylic adhesive.

5. The multi-layer conductive via of claim 1 wherein said flexible substrate preferably comprises a polymer.

6. The multi-layer conductive via of claim 5 wherein said polymer comprises at least one of a polyester or a polycarbonate.

7. The multi-layer conductive via of claim 1 wherein said conductive material layer preferably comprises a conductive ink.

8. The multi-layer conductive via of claim 7 wherein said conductive ink preferably comprises at least one of a silver based ink and a carbon ink.

9. The multi-layer conductive via of claim 7 wherein said adhesive preferably comprises an acrylic adhesive.

10. A multi-layer circuit comprising:
a) a first substrate layer;
b) a conductive circuit formed on said substrate layer using a conductive ink;
c) an adhesive layer having at least one opening formed therein overlying said conductive circuit on said substrate;
d) a flexible layer having at least one opening therein overlying said adhesive layer such that at least one of said openings in said flexible layer is aligned with at least one of said openings in said adhesive layer;
e) a second conductive circuit formed on said flexible layer wherein said circuit lies adjacent to at least one set of aligned openings; and
f) a conductive material layer filling said aligned openings.

11. The multi-layer circuit of claim 10 wherein said conductive circuit preferably comprises at least one of a silver based ink, a carbon ink, and two part cure conductive epoxy.

12. The multi-layer circuit of claim 10 wherein said adhesive layer preferably comprises acrylic adhesive.

13. The multi-layer circuit of claim 10 wherein said substrate layer and said flexible layer preferably comprise a polymer.

14. The multi-layer circuit of claim 13 wherein said polymer comprises at least one of a polyester or a polycarbonate

15. The multi-layer conductive via of claim 10 wherein said conductive material layer preferably comprises a conductive ink.

16. The multi-layer conductive via of claim 15 wherein said conductive ink preferably comprises at least one of a silver based ink and a carbon ink.

17. The multi-layer conductive via of claim 15 wherein said adhesive preferably comprises an acrylic adhesive.

18. The multi-layer circuit of claim 10 further comprising:
a) a plurality of adhesive layers each having at least one opening therein and each overlying a flexible layer having at least one opening therein;
b) a plurality of flexible layers each having at least one opening therein and each overlying an adhesive layer such that at least one of said openings in said flexible layers is aligned with at least one of said openings in said adhesive layers;
c) a plurality of conductive circuits formed on each of said flexible layers such that each of said circuits lies adjacent to at least one of said openings in said flexible layers; and
d) a plurality of conductive material layers filling each of said aligned openings.

19. A method for making a multi-layer conductive via comprising the steps of:
a) forming a first flexible layer;
b) applying a conductive ink to said first layer;
c) applying an adhesive layer having at least one opening therein over said first layer and said conductive ink such that said opening in said adhesive layer overlies said conductive ink;
d) applying a second flexible layer having at least one opening therein over said adhesive layer such that at least one opening in said second flexible layer overlies at least one opening in said adhesive layer; and
e) filling said aligned openings with a conductive material layer.

20. The method of claim 19 further comprising the step of forming a conductive trace on said second flexible layer such that said conductive trace is in contact with said conductive material layer.

21. The method of claim 19 wherein said step of applying a conductive ink to said first layer comprises at least one of screen printing said ink, stencil printing said ink, or directly applying said ink using a syringe dispenser.

22. The method of claim 19 wherein said steps of applying said adhesive layer and applying said second flexible layer each comprise the step of applying pressure to said respective layers.

23. The method of claim 22 wherein said step of applying pressure comprises applying pressure with at least one of a hand roller or opposing machine rollers.

24. The method of claim 19 further comprising the step of curing said conductive material layer at an elevated temperature.

25. The method of claim 19 wherein said step of filling said aligned openings with a conductive material layer comprises the step of filling said aligned openings with a two part cure conductive epoxy which cures at room temperature.

26. A method for making a multi-layer circuit comprising the steps of:
a) forming a first substrate layer;
b) forming a conductive circuit on said substrate layer using a conductive ink;
c) applying an adhesive layer having at least one opening therein over said substrate layer and conductive circuit such that the opening in said adhesive layer overlies said conductive circuit;
d) applying a flexible layer having at least one opening therein over said adhesive layer such that at least one opening in said adhesive layer and at least one opening in said flexible layer are aligned with one another;
e) forming a second conductive circuit on said flexible layer such that said second conductive circuit lies adjacent to at least one set of aligned openings in said adhesive and flexible layers; and
f) filling said aligned openings with a conductive material.

27. The method of claim 26 further comprising the step of alternately applying adhesive layers having at least one opening and flexible layers having at least one opening and at least one conductive circuit formed thereon such that at least one set of openings in said adhesive and flexible layers are aligned with one another and at least one set of aligned openings lies adjacent to said at least one conductive via.

28. The method of claim 26 wherein said step of applying a conductive ink to said first substrate layer comprises at least one of screen printing said ink, stencil printing said ink, or directly applying said ink using a syringe dispenser.

29. The method of claim 26 wherein said steps of applying said adhesive layer and applying said flexible layer each comprise the step of applying pressure to said respective layers.

30. The method of claim 29 wherein said step of applying pressure comprises applying pressure with at least one of a hand roller or opposing machine rollers.

31. The method of claim 26 further comprising the step of curing said conductive material at an elevated temperature.

32. The method of claim 26 wherein said step of filling said aligned openings with a conductive material comprises the step of filling said aligned openings with a two part cure conductive epoxy.
